(19) United States
(12) Patent Application Publication
(10) Pub. No.: US 2010/0250303 A1
(43) Pub. Date: Sep. 30, 2010

(54) COMPUTER IMPLEMENTED RECRUITMENT SYSTEM

(75) Inventors: Robert G. Price, County Down (GB); James W. McNicholas, County Down (GB)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Sell Yourself Recruitment Limited, County Down (GB)

(21) Appl. No.: 12/414,186

(22) Filed: Mar. 30, 2009

(51) Int. Cl. G06Q 10/00; G06F 17/30; G06F 15/16

(52) U.S. Cl. 705/7; 709/203; 707/E17.032

(57) ABSTRACT

A computer-implemented recruitment system comprising a server in communication with clients across a global computer network. The server supports a candidate database containing, in respect of each employment candidate, a candidate data record and a computer-renderable audio-visual file. In response to a view request by a first client in respect of one of said employment candidates, the server provides to the first client the respective audio-visual file and the respective candidate data record, such that said respective audio-visual file and candidate data record may be rendered together to a user at said first client. During registration of a candidate, data concerning the candidate is received in a structured manner according to data type and this facilitates searching by employers.

### FIELD OF THE INVENTION

The invention relates to a computer implemented recruitment system.

### BACKGROUND TO THE INVENTION

Most recruitment organisations operate a business model that relies on human recruitment agents to act as go-betweens between employers and candidates. Typically, individuals seeking employment send their resumes to the recruitment organisation and, when an employer contacts the recruitment organisation with its recruitment needs, a recruitment agent sends to the employer resumes of individuals that he believes to be suitable candidates for the position.

There are a number of perceived shortcomings of this system, including: it is relatively slow; it is dependent on the recruitment agent's ability to select candidates from available resumes;

the number of resumes available to any given agent tends to be relatively small; and it is relatively expensive for the employer since the recruitment organisations tend to charge a fee per successful candidate. Also, traditional recruitment companies tend to limit the number of vacancies that are available to candidates to companies with which they can strike a deal.

Some recruitment organisations such as Monster Worldwide Inc. provide an on-line recruitment system by which employers can perform keyword searching in an on-line database of unstructured resumes that have been submitted by prospective candidates.

However, because the resumes are unstructured, the effectiveness of the keyword searching is limited. Also, the on-line recruitment organisations tend to charge employers based on the number of times they view the database. In addition, such organisations traditionally operate at a regional level.

Moreover, conventional recruitment systems are based on assessment of resumes and it is considered that this is not necessarily the most effective way to assess a candidate especially since, for example, the quality of a resume can vary depending on whether it was prepared by an amateur or with professional help.

It would be desirable, therefore, to provide an improved computer implemented recruitment system.

### SUMMARY OF THE INVENTION

Accordingly, a first aspect of the invention provides a computer-implemented recruitment system comprising: at least one server, said at least one server being enabled for communication with a plurality of clients across a global computer network; and at least one computer usable database including a candidate database, said candidate database containing, in respect of each of a plurality of employment candidates, at least one candidate data record, and at least one computer-renderable audio-visual file, wherein said candidate database is accessible by said at least one server, and wherein, in response to a view request by a first client in respect of one of said employment candidates, said at least one server is arranged to provide to said first client the respective audio-visual file and at least part of the respective candidate data record, or a data record derived therefrom, such that said respective audio-visual file and said at least part of the respective candidate data record, or said data record derived therefrom, may be rendered to a user at said first client.

In typical embodiments, in response to a candidate registration request by a second client, said at least one server is arranged to provide at least one electronic candidate registration form to said second client across said global computer network, said at least one electronic candidate registration form being capable of being rendered to an employment candidate by said second client, and wherein, in response to an indication from said second client that said at least one registration form is completed, said at least one server is arranged to cause a respective candidate data record to be stored in said candidate database, said respective candidate data record comprising data provided by said employment candidate via said second client in response to said at least one registration form when rendered, and wherein, said at least one server is arranged to receive, from said second client, a computer renderable audio-visual file of said employment candidate, and to cause said audio-visual file to be stored in said candidate database linked to said respective candidate data record.

In preferred embodiments, said at least one server comprises a first server for dealing with said view requests, and a second server for dealing with said candidate registration requests.

Preferably, said candidate registration form comprises a plurality of data fields, each data field being associated with a respective data type, said candidate registration form further including means for presenting, when rendered to said employment candidate by said second client, a plurality of data value options in respect of at least some of said data fields, and means for entering into said at least some data fields at least one respective data value option selected by said employment candidate via said second client, said selected data value options being included in said candidate data record for said employment candidate.

In preferred embodiments, in response to a search request by said first client, said at least one server is arranged to provide at least one electronic search form to said first client across said global computer network, said at least one electronic search form being capable of being rendered to an employer by said first client, and wherein, in response to an indication from said first client that said at least one search form is completed, said at least one server is arranged to cause a search of said at least one database to be performed in respect of at least one search criteria derived from said completed search form, and to cause computer renderable search results identifying at least one employment candidate in respect of which said at least one database includes at least one candidate data record to be sent to said first client.

Preferably, said search form comprises a plurality of data fields, each data field being associated with a respective data type, said search form further including means for presenting, when rendered to an employer by said first client, a plurality of data value options in respect of at least some of said data fields, and means for entering into said at least some data fields at least one respective data value option selected by said employer said first client, said selected data value options being used to derive said search criteria.

Advantageously, said candidate registration form and said search form have at least some of said data fields and respective data value options in common.

In typical embodiments, in response to an employer registration request by a client, said at least one server is arranged to provide at least one electronic employer registration form to said client across said global computer network, said at least one electronic employer registration form being capable of being rendered to an employer by said client, and wherein, in response to an indication from said client that said at least one registration form is completed, said at least one server is arranged to cause a respective employer data record to be stored in said at least one database, said respective employer data record comprising data provided by said employer via said client in response to said at least one employer registration form when rendered.

Preferably, said employer registration form comprises a plurality of data fields, each data field being associated with a respective data type, said employer registration form further including means for presenting, when rendered to said employer by said client, a plurality of data value options in respect of at least one of said data fields, and means for entering into said at least one data field at least one respective data value option selected by said employer via said client, said selected data value option being included in said employer data record for said employer.

Advantageously, said employer registration form includes a data field in respect of an industry data type, said data field being associated with a plurality of industry data value options each representing a respective industry or business in respect of which said employer is interested in seeking employment candidates, and wherein said at least one server is arranged to allow said employer to cause searches of said candidate database to be performed only in respect of employment candidates whose respective at least one candidate record indicates that the employment candidate is registered in respect of at least one industry or business corresponding to the or each industry data value option included in said employer's employer data record.

A second aspect of the invention provides a computer-implemented recruitment system comprising: at least one server, said at least one server being enabled for communication with a plurality of clients across a global computer network; and at least one computer usable database including a candidate database, said candidate database containing, in respect of each of a plurality of employment candidates, at least one candidate data record, and at least one computer-renderable audio-visual file, wherein said candidate database is accessible by said at least one server, and wherein, in response to a candidate registration request by a second client, said at least one server is arranged to provide at least one electronic candidate registration form to said second client across said global computer network, said at least one electronic candidate registration form being capable of being rendered to an employment candidate by said second client, and wherein, in response to an indication from said second client that said at least one registration form is completed, said at least one server is arranged to cause a respective candidate data record to be stored in said candidate database, said respective candidate data record comprising data provided by said employment candidate via said second client in response to said at least one registration form when rendered, and wherein, said candidate registration form comprises a plurality of data fields, each data field being associated with a respective data type, said candidate registration form further including means for presenting, when rendered to said employment candidate by said second client, a plurality of data value options in respect of at least some of said data fields, and means for entering into said at least some data fields at least one respective data value option selected by said employment candidate via said second client, said selected data value options being included in said candidate data record for said employment candidate.

A third aspect of the invention provides a method of billing an employer-user of a computer-implemented recruitment system comprising at least one server, said at least one server being enabled for communication with a plurality of clients across a global computer network, and at least one computer usable database including a candidate database, said candidate database containing, in respect of each of a plurality of employment candidates, at least one candidate data record, said method comprising: causing said user to register in respect of at least one of a plurality of business fields; assigning each of said business fields to a respective one of a plurality of tiers; charging said employer-user a fee in respect of the, or each, business in respect of which it is registered depending on which tier the, or each, business is assigned to.

Preferably, said fee is dependant on the number of employees that said employer-user has. More preferably, said fee is dependant on the number of employees that said employer-user has in a predetermined region, e.g. state, country or continent.

A fourth aspect of the invention provides a method of rendering an employment candidate's data to an employer in a computer-implemented recruitment system comprising at least one server, said at least one server being enabled for communication with a plurality of clients across a global computer network; and at least one computer usable database including a candidate database, said candidate database containing, in respect of each of a plurality of employment candidates, at least one candidate data record, said candidate database being accessible by said at least one server, the method comprising providing, in respect of each candidate, at least one computer-renderable audio-visual file; and providing, in response to a view request by a first client in respect of one of said employment candidates, the respective audio-visual file and at least part of the respective candidate data record, or a data record derived therefrom, such that said respective audio-visual file and said at least part of the respective candidate data record, or said data record derived therefrom, may be rendered to a user at said first client.

A fifth aspect of the invention provides a method of receiving an employment candidate's data to an employer in a computer-implemented recruitment system comprising at least one server, said at least one server being enabled for communication with a plurality of clients across a global computer network; and at least one computer usable database including a candidate database, said candidate database containing, in respect of each of a plurality of employment candidates, at least one candidate data record, said candidate database being accessible by said at least one server, the method comprising providing, in response to a candidate registration request by a second client, at least one electronic candidate registration form to said second client across said global computer network, said at least one electronic candidate registration form being capable of being rendered to an employment candidate by said second client; causing, in response to an indication from said second client that said at least one registration form is completed, a respective candidate data record to be stored in said candidate database, said respective candidate data record comprising data provided by said employment candidate via said second client in response to said at least one registration form when rendered, and wherein, said candidate registration form comprises a plurality of data fields, each data field being associated with a respective data type, said candidate registration form further including means for presenting, when rendered to said employment candidate by said second client, a plurality of data value options in respect of at least some of said data fields, and means for entering into said at least some data fields at least one respective data value option selected by said employment candidate via said second client, said selected data value options being included in said candidate data record for said employment candidate.

It will be understood that the term “website” as used herein is intended to embrace any computer useable resource that is made available by a server to clients via a computer network, especially a global computer network such as the Internet. A website typically comprises at least one webpage, wherein the term “webpage” is intended to embrace any computer useable resource that is available to clients via a computer network, especially a global computer network such as the Internet.

Further advantageous aspects of the invention will be apparent to those ordinarily skilled in the art upon review of the following description of a specific embodiment and with reference to the accompanying claims.

### BRIEF DESCRIPTION OF THE DRAWINGS

An embodiment of the invention is now described by way of example and with reference to the accompanying drawings in which:

FIG. 1 is a schematic view of a computer implemented recruitment system embodying the invention;

FIG. 2 is a schematic view of a candidate registration part of the system of FIG. 1;

FIG. 3 is a schematic view of an employer registration part of the system of FIG. 1; and

FIG. 4 is a schematic view of a user access part of the system of FIG. 1.

### DETAILED DESCRIPTION OF THE DRAWINGS

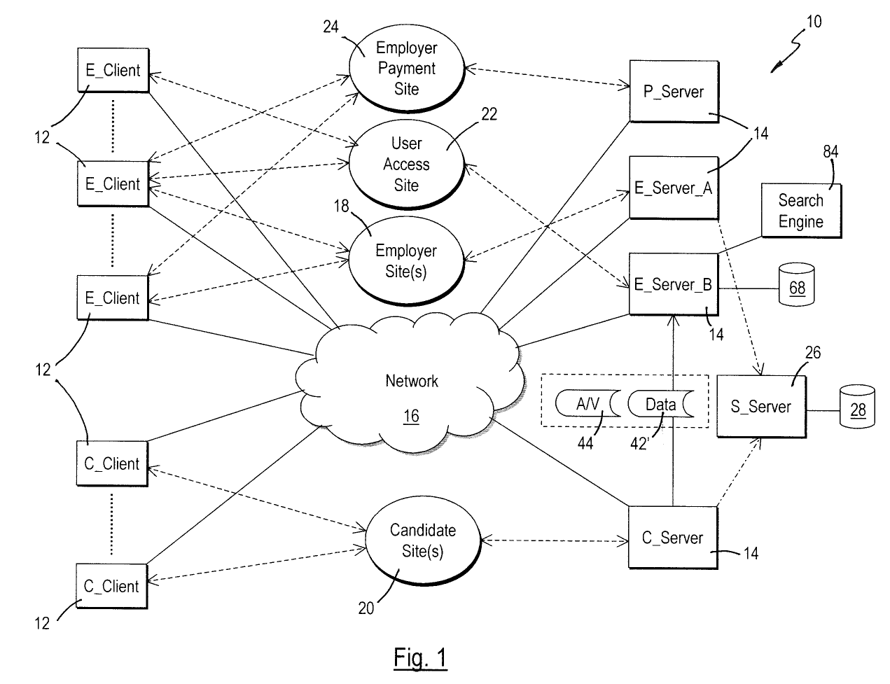

Referring now to FIG. 1 of the drawings there is shown, generally indicated as 10, a computer implemented recruitment system. The system 10 comprises at least one server 14 capable of communicating with a plurality of clients 12 via a computer network 16, typically a global computer network. In the illustrated embodiment, the network 16 comprises the Internet, the servers 14 may be referred to as web servers and the clients may be referred to as web clients. Typically, the clients 12 and servers 14 are implemented by one or more respective computers, for example a PC, supporting suitable computer software to allow communication across the network 16. For example, typical clients 12 support any suitable web browsing, or equivalent, software to enable them to access websites, or equivalent resources, provided by the servers 14.

During use, some of the clients 12 are used by employment candidates (not shown), while others are used by employers (not shown). For the purposes of illustration, in FIG. 1, clients 12 assumed to be used by a candidate are labelled C_Client, while clients 12 assumed to be used by employers are labelled E_Client.

In the preferred embodiment, a plurality of servers 14 are provided. A first server 14, which is labelled E_Server_A in FIG. 1, is arranged to provide on-line resources to the clients 12, conveniently by means of at least one employer website 18, by which employers can register with the system 10 via their client 12. A second server 14, which is labelled C_Server in FIG. 1, is arranged to provide on-line resources to the clients 12, conveniently by means of at least one candidate website 20, or equivalent on-line resource, by which candidates can register with the system 10 via their client 12. A third server 14, which is labelled E_Server_B in FIG. 1, is arranged to provide on-line resources to the clients 12, conveniently by means of at least one user access website 22, or equivalent on-line resource, by which users can search, via their client, though one or more databases supported by the system 10 as is described in more detail hereinafter. The websites 18, 20, 22 serve as interfaces by which the clients 12, and their users, can interact with the servers 14.

Typically, the users that are able to search via the user access website 18 are employers who have registered with the system 10. The provision of more than one server as described above is advantageous for reasons of security and robustness. For example, should the security of one server be breached, or should one server fail, the other server(s) are unaffected. However, it will be understood that, in alternative embodiments (not illustrated), each of the websites 18, 20, 22, or any two or more of the websites 18, 20, 22, may be supported by a common server. For security reasons, however, it is preferred to provide at least the third server (E_Server_B) as a separate server to prevent unauthorised access to candidate and employer data received via the websites 18, 20.

Optionally, a fourth server 14, which is labelled P_Server in FIG. 1, may be included to provide on-line resources to the clients 12, conveniently by means of at least one payment website 24 by which employers may make payments to the operator (not shown) of the system 10. Preferably, the fourth server 14 is operated by a third party, i.e. an operator other than the operator of the system 10. For example; the on-line payment resource provided by PayPal (Europe) Sarl & Cie of Luxembourg, is suitable for use as the payment website 24.

Preferably, for reasons of security, the system 10 includes a separate computer 26 arranged to support a database 28 of candidate and employer data. The computer 26 is preferably not in communication with the other computers 12, 14 of the system 10 via network 16 or any other permanent connection, such that accessing the database 28 can only be achieved by a human operator who can physically access the computer in person, for example by means of portable data storage media or by setting up a communication link, e.g. a Bluetooth or infrared link, between the computer 26 and another computer.

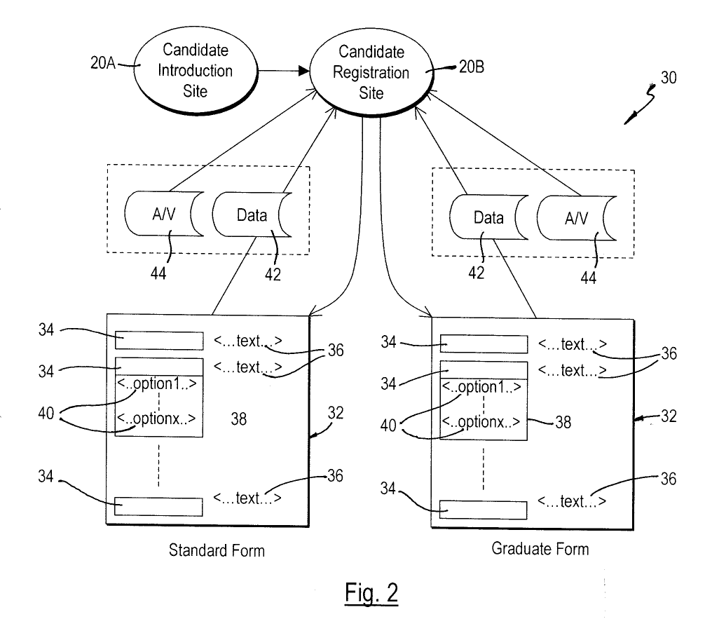

Referring now to FIG. 2 of the drawings there is shown, generally indicated as 30, a candidate registration part of the system 10. The candidate registration part 30 comprises the candidate website(s) 20 which includes a candidate registration website 20A and, optionally, a candidate introduction website 20B. In the preferred embodiment, the candidate introduction website 20B is arranged to provide introductory information on the system 10 to prospective candidates and to direct the candidate's client computer 12 to the candidate registration website 20A should they choose to register with the system 10. This may be achieved by any suitable means, for example by the candidate activating a hyperlink (not illustrated) on the introduction website 20B, or automatically depending on how the candidate interacts with the website 20B. In alternative embodiments, the introduction website 20B may be omitted and, if desired, one or more introductory webpages may be included in the registration website 20A. In general, the provision of multiple websites 18A, 18B, 20A, 20B is preferred because it makes the system more robust. For example, should one website fail, the others may still function. However, one or more of the websites 18A, 18B, 20A, 20B may alternatively be provided on a common website.

The candidate registration website 20A is arranged to render to the candidate at the candidate's client computer 12 at least one structured electronic candidate registration form 32, for example a web form. The registration form 32 exposes at least one, but typically a plurality of, data fields 34 into which the candidate may enter data via his client computer 12. A respective text string 36 is displayed in association with each data field 34, the content of the respective text string 36 indicating to the candidate what type of data is required for the respective field. At least some of the data fields 34 are completed, during use, by means of a respective associated menu 38 presenting a plurality of data options 40 to the candidate. In use, the candidate selects, via his client computer 12, at least one data option 40 from the respective menu 38 for each data field 34. The selected data option 40 is then entered into the respective data field 34. The respective data options 40 for each field 34 take the form of data that is relevant to the text string 36 associated with the respective field 34.

In the preferred embodiment, one or more respective data fields may be provided for one or more of the following data types:

Personal Details—1. Salutation; 2. Name; 3. Physical address; 4. Nearest city to candidate's physical location; 5. Post/ZIP code; 6. Country; 7. Date of Birth; 8. Primary qualification achieved; 9. Subject Area of primary qualification or study; 10. Country in which primary qualification was attained; 11. Date on which qualification was attained; 12. Secondary qualification details; 13. Year secondary qualification attained; 14. Languages in which candidate is fluent; 15. Additional information.

Job Seeker Information—16. Main industry in respect of which the candidate wishes his details to be made available to employers; 17. Role being sought within the selected main industry; 18. Country in which the candidate would prefer to work; 19. Nearest city in which the candidate would prefer to work; 20. Type of work sought (e.g. full-time, part-time or job share); 21. Does the candidate have experience in the selected industry and/or role?; 22. Length of experience; 23. Willingness to take shift-work; 24. Number of hours per day, week and or month that candidate is available for work; 25. Months of year that candidate is available for work (for seasonal workers); 26. Current status (employed or unemployed); 27. Does the candidate have a driving licence?; 28. Contact email address; 29. Contact telephone number.

It will be seen from the foregoing that it is preferred to define the form 32 in two parts, namely a Personal Details part and a Job Seeker Information part. Each part may be presented to the candidate simultaneously or in sequence and may be presented separately from or concatenated with the other part.

By way of example, the respective data fields 34 for one or more of data types 1, 4, 6, 7 to 14, and 16 to 27 may be completable by means of a respective menu 38 of suitable data value options 40. The data value options 40 provided by at least some of the menus 38 may be dynamic, and in particular may be dependent on the data option 40 selected in respect of another data field 34. For example, the options 40 provided in respect of data type 17 may be dependant on the data option selected for data type 16. At least some data fields 34 may allow more than one data option to be selected (for example the fields for data types 17, 18, 19 and/or 20).

The respective data fields 34 for some data types, e.g. data types 2, 3, 15, 28 and 29, may allow the candidate to enter data into the field 34 in a freeform manner.

In the preferred embodiment, the candidate registration website 20A is arranged to render to the candidate one of two candidate registration forms 32 available for selection by the candidate. The first form 32 is suitable for use by candidates who are currently available for employment, e.g. candidates seeking employment immediately or in the imminent future (this is represented in FIG. 2 as the “Standard” form 32). The second form 32 is suitable for use by candidates who are not currently available for employment but will become available for employment in the foreseeable future. The second form 32 is particularly suitable for use by individuals in education, e.g. undergraduates, post-graduates or other students. The second form 32 is represented in FIG. 2 as the “Graduate” form 32. Both the Standard and Graduate forms 32 are generally of the type described above and usually have data fields 34 for at least some of the data types listed above (the Standard form 32 typically includes fields 34 for at least some and preferably all of the data types listed above). However, the Graduate form may include one or more fields 34 for data types that are not applicable to non-student candidates (and vice versa). For example, the Graduate form 32 may include a respective data field 34 for one or more of the following data types: expected grades; examination results to date; expected graduation date; date on which candidate is expected to be available for employment.

When the candidate has completed the registration form 32, he submits it to the website 20A. This results in a candidate's data file 42 being communicated to the server C_Server via the website 20A. The candidate's data file 42 contains the information entered into the form 32 by the candidate. Advantageously, because of the configuration of the registration form 32, at least some of the data contained within the data file 42 is in a structured form whereby, in respect of a plurality of data types (as provided for by the respective data fields 34), there is stored at least one pre-defined and therefore recognisable data value (as provided by the data option 40 selected from the respective menu 38).

In addition to the data file 42, the candidate registration website 20A allows (and in the preferred embodiment requires) the candidate to submit an A/V (audio/visual) file 44 of himself. The A/V file 44 comprises an audio and visual recording of the candidate revealing recruitment related information about himself, and is hereinafter referred to as the Audio/Visual Recruitment Profile (AVRP). Preferably, in the AVRP 44 the candidate provides information on one or more topics that are stipulated by the candidate website 20 (typically the candidate registration website 20A). For example, the candidate may answer one or more of the following questions (one or more of which may be mandatory): What is your name, age and country of residence? What is your life ambition? What are your personality strengths? What do you expect from an employer? Who do you consider to be your role model? The AVRP 44 is preferably of restricted duration, e.g. 5 minutes, and the system 10 may monitor this by any suitable means (e.g. size of the A/V file). The AVRP 44 may be created in any conventional manner, for example using a webcam (not shown) and associated computer software at the candidate's computer 12.

Once the AVRP 44 has been created, it is submitted to the website 20A such that it is communicated to the server C_Server 14. The AVRP 44 and the respective data file 42 for the same candidate are stored together, i.e. in association with one another, at the server C_Server 14. Preferably, the AVRP 44 and the respective data file 42 are linked together, by any suitable means, e.g. by assigning a unique identifier to the AVRP 44 and its associated data file 42, so that they may be retrieved together when required.

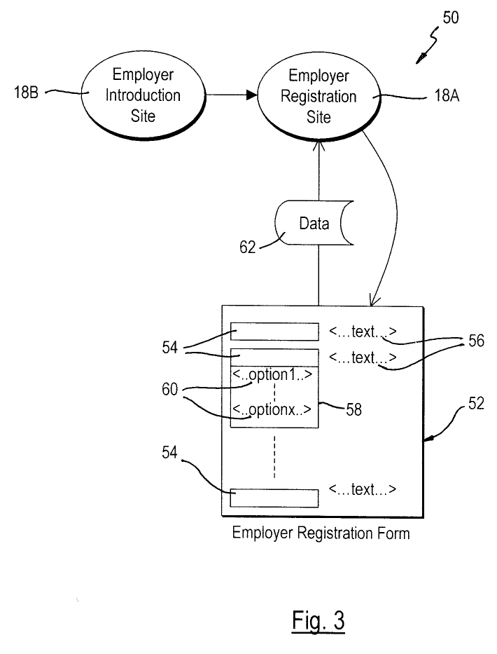

Referring now to FIG. 3 of the drawings there is shown, generally indicated as 50, an employer registration part of the system 10. The employer registration part 50 comprises the employer website(s) 18 which includes an employer registration website 18A and, optionally, an employer introduction website 18B. In the preferred embodiment, the employer introduction website 18B is arranged to provide introductory information on the system 10 to prospective employers and to direct the employer's client computer 12 to the employer registration website 18A should they choose to register with the system 10. This may be achieved by any suitable means, for example by the employer activating a hyperlink (not illustrated) on the introduction website 18B, or automatically depending on how the candidate interacts with the website 18B. In alternative embodiments, the introduction website 18B may be omitted and, if desired, one or more introductory webpages may be included in the registration website 18A.

The employer registration website 18A is arranged to render to the employer at the employer's client computer 12 at least one structured electronic employer registration form 52, for example a web form. The registration form 52 exposes at least one, but typically a plurality of, data fields 54 into which the employer may enter data via his client computer 12. A respective text string 56 is displayed in association with each data field 54, the content of the respective text string 56 indicating to the employer what type of data is required for the respective field 54. At least one of the data fields 54 may be completed, during use, by means of a respective associated menu 58 presenting a plurality of data options 60 to the employer. In use, the employer selects, via his client computer 12, at least one data option 60 from the respective menu 58 for each data field 54. The selected data option 60 is then entered into the respective data field 54. The respective data options 60 for each field 54 take the form of data that is relevant to the text string 56 associated with the respective field 54.

In the preferred embodiment, one or more respective data fields may be provided for one or more of the following data types: 1. Business name; 2. Contact name; 3. Contact title/position; 4. Business (physical) address; 5. City; 6. County/State; 7. Country; 8. Post/ZIP code; 9. Contact email; 10. Company website; 11. Contact telephone number; 12. Company registration number; 13. Country of registration; 14. Main Industry Activity; 15. Number of employees.

Advantageously, an options menu 58 is provided for the field 54 for data type 14—Main Industry Activity. In typical embodiments, the employer may enter data into the other fields 54 using freeform text entry. Optionally, the field for entering number of employees may stipulate that it is the number of employees in total, and/or in a particular country or countries and/or within a particular business sector or sectors. If required, more than one data fields may be provided to receive information on the number of employees.

When the employer has completed the registration form 52, he submits it to the website 18A. This results in an employer's data file 62 being communicated to the server F_Server_A via the website 18A. The employer's data file 62 contains the information entered into the form 52 by the employer. Advantageously, because of the configuration of the registration form 52, at least some of the data contained within the data file 62 is in a structured form whereby, in respect of at least one data type (as provided for by the respective data field 54), there is stored at least one pre-defined and therefore recognisable data value (as provided by the data option 60 selected from the respective menu 58).

In the preferred embodiment, employers are required to pay for their participation in the system prior to their registration being completed. This may be achieved by redirecting the employer's client computer 12 to the payment website 24 before registration is completed. For example, the redirection may be effected once the employer has completed the form 52 and submitted it to the website 18A. Once payment has been effected, the server E_Server_A completes the employer's registration by accepting the submitted form 52 as valid and allocating a unique identifier to the employer's record. The server E_Server_A (or any other suitable part of the system 10) may then cause an email to be sent to the employer confirming registration and providing him with the unique identifier, and typically also a password. The identifier and password may subsequently be used by the employer to access the user access site 22 as is described in more detail hereinafter.

From time to time data, including the data files 42, 64 and the AVRPs 44, that is received by E_Server_A and C_Server via the respective websites 18, 20 is copied to the database 28 via computer 26. Conveniently, the data is stored in one or more respective database records for each candidate or employer. The transfer of data from the servers 14 to computer 26 is preferably performed manually, e.g. using portable data storage media (such as a memory stick or disc), or by manually setting up a temporary communications link. Where portable storage media are used, the media is preferably checked for viruses before being connected to the computer 26. Hence, the database 28 provides a secure permanent storage of employer and candidate data.

Candidate data that is received by E_Server_A and C_Server via the respective websites 18, 20 is electronically transferred to the server E_Server_B so that it may be accessed via the user access website 22. The transferred data includes, in respect of each candidate, the respective AVRP 44 and a respective data file 42′ (FIG. 1), and is stored in a database or other data storage facility 68 supported by server E_Server_B. Conveniently, the data is stored in one or more respective database records for each candidate. In the preferred embodiment, the data file 42′ is derived from the respective data file 42 and contains only some of the data contained in the corresponding data file 42 for the respective candidate. For example, it is preferred that at least the candidate's telephone number and address are not included in the data file 42′. For example, all of the data relating to items 1 to 29 listed above in relation to the candidates registration form may be included in the restricted data file 42′ except for the address (item 3), the ZIP code (item 5) and the telephone number (item 29).

The data file 42′ is linked with the respective AVRP 44 such that, when the AVRP 44 is rendered to a user via the user access website 22, the candidate data, or at least some of it, contained in the respective data file 42′ is also rendered, preferably simultaneously, to the user. The data rendered from the data file 42′ typically includes text providing information on the candidate. For example, the text may provide information on the candidate's education/qualifications and/or employment history. The data file 42′ and respective AVRP 44 may be linked together by assigning a common unique identifier to each of them. Typically the same respective unique identifier is also assigned to the respective data file 42. The assignment of unique identifiers and the creation of the restricted data file 42′ from the respective data file 42 may be performed by C_server.

Hence when an employer selects a candidate via the user access website 22, server E_Server_B renders to him the candidate's AVRP 44 and the candidate data stored in the associated data file 42′, so that he can view/listen to the AVRP 44 while reading the rendered text.

In the preferred embodiment, when the data, including the data files 42, 64 and the AVRPs 44, that is received by E_Server_A and C_Server via the respective websites 18, 20, has been transferred to the database 28 and to the server E_Server_B, it is deleted from the servers E_Server_A and C_Server as applicable.

The manner in which the candidate's data is obtained and stored (as described above in relation to the registration form 32) facilitates specific item searching as opposed to keyword searching. In particular, at least some of each candidate's data is stored as a selected data value option 40 for a respective data type associated with the respective data field 34. This allows users of the user access website 22 to search through candidate's data stored on database 68 by specific data value options for specific data types. Moreover, this allows the user's search to be performed using a search form comprising data fields and option menus.

It will be apparent that the data contained in the restricted data file 42′ not only provides data to allow the employer to search through candidate records, but also provides data that can be rendered to the employer in association with the candidate's AVRP 44. It will be understood that not all of the data in the restricted file 42′ need be rendered in association with the AVRP 44. Data in respect of any combination of one or more of the data types 1, 2, 4, 6 to 15, and 16 to 28 may be rendered in association with the AVRP, as desired.

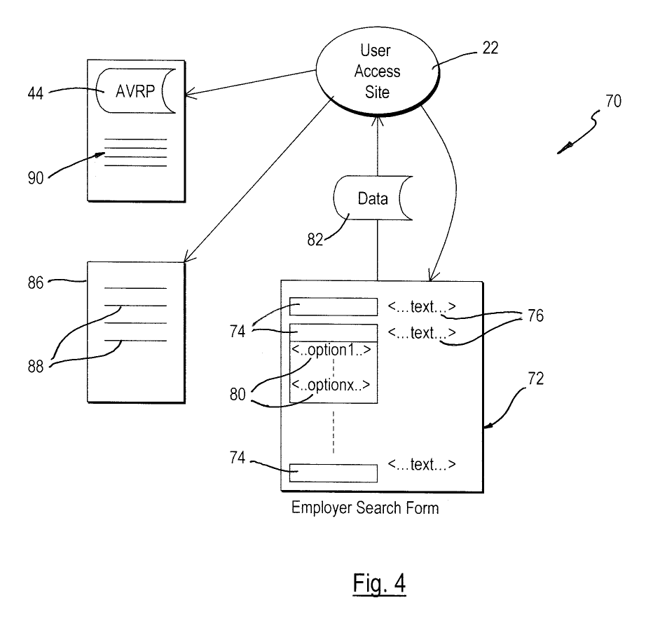

Referring now to FIG. 4 of the drawings there is shown, generally indicated as 70, a user access part of the system 10. The user access part 70 comprises the user access website(s) 22. In the preferred embodiment, authorised users of this part of the system 10 are registered users and in particular users that have registered as an employer via the employer registration website 18A. Any suitable login facility may be provided to prevent non-authorised users from using the website 22.

The user access website 22 is arranged to render to the user at the user's client computer 12 at least one structured electronic candidate search form 72, for example a web form. The search form 72 exposes at least one, but typically a plurality of, data search fields 74 into which the user may enter data via his client computer 12. A respective text string 76 is displayed in association with each data field 74, the content of the respective text string 76 indicating to the user what type of data is required for the respective field 74. At least one, and optionally all, of the data fields 74 may be completed, during use, by means of a respective associated menu 78 presenting a plurality of data options 80 to the user. In use, the user selects, via his client computer 12, at least one data option 80 from the respective menu 78 for each data field 74. The selected data option 80 is then entered into the respective data search field 74. The respective data options 80 for each field 74 take the form of data that is relevant to the text string 76 associated with the respective field 74.

In the preferred embodiment, each data search field 74 corresponds to a respective one of the data fields 34 in the candidate registration form 32. For example, a respective data search field 74 may be provided for one or more of data types 4, 6, 7 to 14, 16 to 27, listed above in connection with the candidate registration form. Moreover, it is further preferred that the respective data value options 80 for each field 74 correspond with (e.g. may be the same as) the respective data value options 40 for the respective data field 34.

In the preferred embodiment, the user is only able to search in respect of the, or each, industry in respect of which he is registered (as determined in this example by the data value option 60 selected for the “Main Industry Activity” data type in the employer registration form 52), and so can also access data in respect of candidates who have also registered in the same industry or industries.

When the user has completed the search form 72, he submits it to the website 22. This results in a user's search file 82 being communicated to the server E_Server_B via the website 22. The search file 82 contains the information entered into the form 72 by the user. Advantageously, because of the configuration of the registration form 72, at least some of the data contained within the search file 82 is in a structured form whereby, in respect of at least one data type (as provided for by the respective data field 74), there is stored at least one pre-defined and therefore recognisable data value (as provided by the data option 80 selected from the respective menu 78).

The server E_Server_B includes, or has access to, a search engine 84 (which may take any suitable conventional form) and, upon receipt of a search file 82, the server E_Server_B causes the search engine 84 to search through the database 68 using search criteria defined by the data value options 80 and associated data types. The search engine 84 returns a set of results 86, which are rendered to the user via the website 22 and his client computer 12 in any suitable form, as illustrated by way of example in FIG. 4. The results set 86 typically includes a list of candidates that match the search criteria. The rendered results set 86 preferably includes a respective activatable link 88 for each candidate in the list. Upon activation of any of said links 88 by the user, the respective AVRP 44 and associated text 90 are rendered to the user via the website 22 and his client computer 12 in any suitable form, as illustrated by way of example in FIG. 4.

As a result of the structured nature of the stored candidate's information and of the search form, the result set 86 returned by the search engine 84 are considered to list candidates that are more likely to meet the user's requirements and to omit fewer candidates that are likely to meet the user's requirements that is possible with keyword searching.

Should the user identify a candidate that warrants further contact, the user may contact the candidate directly. To this end, the text 90 conveniently includes contact details, preferably limited contact details, for example an email address only, for the candidate.

In the preferred embodiment, employers who register with the system are charged a fixed fee for a period of registration, for example one year. As previously described, the employer advantageously pays the fixed fee at the time of registration. During the period of registration, the employer is able to search the database 68 as many time as it wishes and view data concerning, contact and/or employ as many candidates as it wishes without incurring additional fees.

Preferably, the fixed fee charged to an employer is dependant on the, or each, main industry in respect of which the employer registers. It is further preferred that the fixed fee charged to an employer is dependent on the number employees that the employer has. The number of employees may be taken globally or nationally and/or in a particular business sector(s), and so the fee may be calculated based on the number of employees that an employer has in total, or in a particular country and/or in a particular business sector(s).

For example, in the illustrated embodiment, the employer registration form 52 includes a field 52 for the data type “Main Industry Activity”. To complete this field, the employer is provided with a plurality of data value options 60 from which to choose, each data value option 60 representing an industry or business sector in respect of which the employer's registration is to take place. The data value options 60 for “Main Industry Activity” are notionally divided into a plurality of tiers depending on, for example, the expected wealth generation of organisations/businesses that are deemed to fall within the “Main Industry Activity”, or other desired criterion. The fixed fee charged to the employer is dependant on the tier of the “Main Industry Activity” in respect of which it registers. In respect of each tier, a plurality of possible fixed fees are defined, the fee applicable to the employer being determined by the number of employees that the employer has.

In the illustrated embodiment, the employer registration form 52 allows for a single industry to be selected by the employer. Should the employer wish to register in respect of more than one industry, it may register separately in respect of each industry of interest, and so be charged in respect of each registration. In alternative embodiments, the employer registration form may allow the employer to register in respect of multiple industries, and so to be charged in respect of each selected industry. The employer may also select to register in respect of graduates and/or standard candidates. A separate fee may be charged in respect of each.

The invention is not limited to the embodiments described herein, which may be modified or varied without departing from the scope of the invention.

1. A computer-implemented recruitment system comprising:
at least one server, said at least one server being enabled for communication with a plurality of clients across a global computer network; and
at least one computer usable database including a candidate database, said candidate database containing, in respect of each of a plurality of employment candidates, at least one candidate data record, and at least one computer-renderable audio-visual file, wherein said candidate database is accessible by said at least one server,
and wherein, in response to a view request by a first client in respect of one of said employment candidates, said at least one server is arranged to provide to said first client the respective audio-visual file and at least part of the respective candidate data record, or a data record derived therefrom, such that said respective audio-visual file and said at least part of the respective candidate data record, or said data record derived therefrom, may be rendered to a user at said first client.

2. A system as claimed in claim 1, wherein, in response to a candidate registration request by a second client, said at least one server is arranged to provide at least one electronic candidate registration form to said second client across said global computer network, said at least one electronic candidate registration form being capable of being rendered to an employment candidate by said second client, and wherein, in response to an indication from said second client that said at least one registration form is completed, said at least one server is arranged to cause a respective candidate data record to be stored in said candidate database, said respective candidate data record comprising data provided by said employment candidate via said second client in response to said at least one registration form when rendered, and wherein, said at least one server is arranged to receive, from said second client, a computer renderable audio-visual file of said employment candidate, and to cause said audio-visual file to be stored in said candidate database linked to said respective candidate data record.

3. A system as claimed in claim 1, wherein said at least one server comprises a first server for dealing with said view requests, and a second server for dealing with said candidate registration requests.

4. A system as claimed in claim 2, wherein said at least one candidate registration form comprises a plurality of data fields, each data field being associated with a respective data type, said candidate registration form further including means for presenting, when rendered to said employment candidate by said second client, a plurality of data value options in respect of at least some of said data fields, and means for entering into said at least some data fields at least one respective data value option selected by said employment candidate via said second client, at least some of said selected data value options being included in said candidate data record for said employment candidate.

5. A system as claimed in claim 1, wherein in response to a search request by said first client, said at least one server is arranged to provide at least one electronic search form to said first client across said global computer network, said at least one electronic search form being capable of being rendered to an employer by said first client, and wherein, in response to an indication from said first client that said at least one search form is completed, said at least one server is arranged to cause a search of said at least one database to be performed in respect of at least one search criteria derived from said completed search form, and to cause computer renderable search results identifying at least one employment candidate in respect of which said at least one database includes at least one candidate data record to be sent to said first client.

6. A system as claimed in claim 5, wherein said search form comprises a plurality of data fields, each data field being associated with a respective data type, said search form further including means for presenting, when rendered to an employer by said first client, a plurality of data value options in respect of at least some of said data fields, and means for entering into said at least some data fields at least one respective data value option selected by said employer said first client, said selected data value options being used to derive said search criteria.

7. A system as claimed in claim 1, wherein in response to an employer registration request by a client, said at least one server is arranged to provide at least one electronic employer registration form to said client across said global computer network, said at least one electronic employer registration form being capable of being rendered to an employer by said client, and wherein, in response to an indication from said client that said at least one registration form is completed, said at least one server is arranged to cause a respective employer data record to be stored in said at least one database, said respective employer data record comprising data provided by said employer via said client in response to said at least one employer registration form when rendered.

8. A system as claimed in claim 7, wherein said employer registration form comprises a plurality of data fields, each data field being associated with a respective data type, said employer registration form further including means for presenting, when rendered to said employer by said client, a plurality of data value options in respect of at least one of said data fields, and means for entering into said at least one data field at least one respective data value option selected by said employer via said client, said selected data value option being included in said employer data record for said employer.

9. A system as claimed in claim 8, wherein said employer registration form includes a data field in respect of an industry data type, said data field being associated with a plurality of industry data value options each representing a respective industry or business in respect of which said employer is interested in seeking employment candidates, and wherein said at least one server is arranged to allow said employer to cause searches of said candidate database to be performed only in respect of employment candidates whose respective at least one candidate record indicates that the employment candidate is registered in respect of at least one industry or business corresponding to the or each industry data value option included in said employer's employer data record.

10. A system as claimed in claim 4, wherein said respective candidate data record comprises only part of said data provided by said employment candidate via said second client in response to said at least one registration form when rendered.

11. A system as claimed in claim 10, wherein said candidate registration form includes at least one data field for receiving data representing at least one telephone number of said employment candidate, said at least one server being arranged to cause said data representing said at least one telephone number to be omitted from the respective candidate data record for the respective employment candidate.

12. A system as claimed in claim 10, wherein said candidate registration form includes at least one data field for receiving data representing at least one physical address of said employment candidate, said at least one server being arranged to cause said data representing said at least one physical address to be omitted from the respective candidate data record for the respective employment candidate.

13. A system as claimed in claim 10, wherein said candidate registration form includes at least one data field for receiving data representing at least one industry or business in which the respective employment candidate wishes to work, said at least one server being arranged to cause said data representing said at least one industry or business to be included in the respective candidate data record for the respective employment candidate.

14. A system as claimed in claim 13, wherein said candidate registration form includes at least one data field for receiving data representing at least role within said at least one industry or business in which the respective employment candidate wishes to work, said at least one server being arranged to cause said data representing said at least one role to be included in the respective candidate data record for the respective employment candidate.

15. A system as claimed in claim 10, wherein said candidate registration form includes at least one data field for receiving data representing at least one email address for the respective employment candidate, said at least one server being arranged to cause said data representing said at least one email address to be included in the respective candidate data record for the respective employment candidate.

16. A system as claimed in claim 15, wherein said at least one server is arranged to cause said at least one email address to be rendered to said user at said first client in association with the respective audio-visual file for said respective employment candidate.

17. A system as claimed in claim 10, wherein said candidate registration form includes at least one data field for receiving data representing at least one of the following data types relating to the respective employment candidate: name; nearest city to candidate's physical location; physical address; country of residence; date of birth; primary qualification achieved; subject area of primary qualification or study; country in which primary qualification was attained; date on which qualification was attained; secondary qualification details; year secondary qualification attained; languages in which candidate is fluent; main industry in respect of which the candidate wishes his details to be made available to employers; role being sought within the selected main industry; country in which the candidate would prefer to work; nearest city in which the candidate would prefer to work; experience in the selected industry and/or role; length of experience; willingness to take shift-work; number of hours per day, week and or month that candidate is available for work; months of year that candidate is available for work; current employment status; driving licence; contact email address; contact telephone number, said at least one server being arranged to cause said data representing said data types to be included in the respective candidate data record for the respective employment candidate.

18. A system as claimed in claim 4, wherein in response to a search request by said first client, said at least one server is arranged to provide at least one electronic search form to said first client across said global computer network, said at least one electronic search form being capable of being rendered to an employer by said first client, and wherein, in response to an indication from said first client that said at least one search form is completed, said at least one server is arranged to cause a search of said at least one database to be performed in respect of at least one search criteria derived from said completed search form, and to cause computer renderable search results identifying at least one employment candidate in respect of which said at least one database includes at least one candidate data record to be sent to said first client, and wherein said search form comprises a plurality of data fields, each data field being associated with a respective data type, said search form further including means for presenting, when rendered to an employer by said first client, a plurality of data value options in respect of at least some of said data fields, and means for entering into said at least some data fields at least one respective data value option selected by said employer said first client, said selected data value options being used to derive said search criteria, and wherein at least some of the data types in respect of which said search form has data fields are the same as the data types in respect of which said candidate registration form has data fields.

19. A system as claimed in claim 2, wherein each audio-visual file and respective candidate data record are linked together by assignment to a respective unique identifier.

20. A system as claimed in claim 4, wherein said at least one candidate registration form includes a student candidate registration form, said student registration form including at least one data field for receiving data representing at least one of the following data types relating to the respective student employment candidate: subject being studied; qualification being sought; date on which student employment candidate is available for employment.

21. A computer-implemented recruitment system comprising:
at least one server, said at least one server being enabled for communication with a plurality of clients across a global computer network; and
at least one computer usable database including a candidate database, said candidate database containing, in respect of each of a plurality of employment candidates, at least one candidate data record, and at least one computer-renderable audio-visual file, wherein said candidate database is accessible by said at least one server,
and wherein, in response to a candidate registration request by a second client, said at least one server is arranged to provide at least one electronic candidate registration form to said second client across said global computer network, said at least one electronic candidate registration form being capable of being rendered to an employment candidate by said second client, and wherein, in response to an indication from said second client that said at least one registration form is completed, said at least one server is arranged to cause a respective candidate data record to be stored in said candidate database, said respective candidate data record comprising data provided by said employment candidate via said second client in response to said at least one registration form when rendered, and wherein, said candidate registration form comprises a plurality of data fields, each data field being associated with a respective data type, said candidate registration form further including means for presenting, when rendered to said employment candidate by said second client, a plurality of data value options in respect of at least some of said data fields, and means for entering into said at least some data fields at least one respective data value option selected by said employment candidate via said second client, said selected data value options being included in said candidate data record for said employment candidate.

22. A method of billing an employer-user of a computer-implemented recruitment system comprising at least one server, said at least one server being enabled for communication with a plurality of clients across a global computer network, and at least one computer usable database including a candidate database, said candidate database containing, in respect of each of a plurality of employment candidates, at least one candidate data record, said method comprising:
causing said user to register in respect of at least one of a plurality of business fields;
assigning each of said business fields to a respective one of a plurality of tiers; and
charging said employer-user a fee in respect of the, or each, business in respect of which it is registered depending on which tier the, or each, business is assigned to.

23. A method as claimed in claim 22, wherein said fee is dependant on the number of employees that said employer-user has.

24. A method as claimed in claim 22, wherein said fee is dependant on the number of employees that said employer-user has in at least one country in respect of which the employer-user has registered.

25. A method as claimed in claim 23, wherein said fee is dependant on the number of employees that said employer-user has in said at least one business field.
